(19) United States
(12) Patent Application Publication
(10) Pub. No.: US 2024/0064413 A1
(43) Pub. Date: Feb. 22, 2024

(54) COMFORTABLE MULTIPLEXED LIGHTING FOR MODELING RELIGHTABLE AVATARS

(71) Applicant: Meta Platforms Technologies, LLC, Menlo Park, CA (US)

(72) Inventors: Jason Saragih, Pittsburgh, PA (US); Tomas Simon Kreuz, Pittsburgh, PA (US); Kevyn Alex Anthony McPhail, Pittsburgh, PA (US); María Murcia López, Valencia (ES)

(21) Appl. No.: 18/067,587

(22) Filed: Dec. 16, 2022

Related U.S. Application Data
(60) Provisional application No. 63/399,994, filed on Aug. 22, 2022.

(51) Int. Cl. H04N 23/74; H04N 23/56; H04N 23/90; H04N 5/262; H04N 23/73; H04N 23/72

(52) U.S. Cl. CPC H04N 23/74; H04N 23/56; H04N 23/90; H04N 5/2621; H04N 23/73; H04N 23/72

(57) ABSTRACT

A method to generate relightable avatars with an arbitrary illumination configuration is provided. The method includes selecting a lighting configuration for collecting a sequence of pictures of a subject, the lighting configuration including a spatial pattern with multiple lights surrounding the subject and a time lapse pattern with multiple camera exposure windows, modifying the spatial pattern and the time lapse pattern based on an average illumination intensity provided to the subject, activating the lights in a sequence based on the spatial pattern and the time lapse pattern, and collecting multiple pictures from multiple cameras surrounding the subject at each of the camera exposure windows. A memory storing instructions, a processor configured to execute the instructions, and a system which is caused, upon the executed instructions, to perform the above method, are also provided.

### CROSS-REFERENCE TO RELATED APPLICATIONS

The present disclosure is related and claims priority under 35 U.S.C. § 119(e), to U.S. Prov. Appln. No. 63/399,994, entitled COMFORTABLE MULTIPLEXED LIGHTING FOR MODELING RELIGHTABLE AVATARS, on Aug. 22, 2022 to Jason SARAGIH, et al., the contents of which are hereby incorporated by reference in their entirety, for all purposes.

### BACKGROUND

### Field

The present disclosure is related generally to the field of modeling relightable avatars. More specifically, the present disclosure is related to illumination schemes for enhancing the comfort of subjects in the generation of relightable avatars.

### Related Art

Animatable photorealistic digital humans are a key component for enabling social telepresence, with the potential to open up a new way for people to connect while unconstrained to space and time. The ability to adjust lighting conditions for a given three-dimensional computer model is highly desirable, to immerse an avatar in a virtual scene of choice. Modeling of different lighting conditions for relightable avatars typically submits subjects to strenuous conditions, which may cause a biased response in terms of facial expression. Accordingly, it is desirable to reduce the stress for the subjects in lighting sessions, so that truly, unbiased model expressions are captured under different lighting conditions.

### SUMMARY

In a first embodiment, a computer-implemented method includes selecting a lighting configuration for collecting a sequence of pictures of a capturing subject, the lighting configuration including a spatial pattern with multiple lights surrounding the subject and a time lapse pattern with multiple camera exposure windows, modifying the spatial pattern and the time lapse pattern based on an average illumination intensity provided to the capture subject, controlling a perceived brightness of the lights for the capturing subject by synchronously adjusting the time lapse pattern, the camera exposure windows and a brightness of the lights, activating the lights in a sequence based on the spatial pattern and the time lapse pattern, and collecting multiple pictures from multiple cameras surrounding the subject at each of the camera exposure windows.

In a second embodiment, a system includes a memory storing multiple instructions and one or more processors configured to execute the instructions to cause the system to perform operations. The operations include to select a lighting configuration for collecting a sequence of pictures of a subject, the lighting configuration including a spatial pattern with multiple lights surrounding the subject and a time lapse pattern with multiple camera exposure windows, to modify the spatial pattern and the time lapse pattern based on an average illumination intensity provided to the subject, to activate the lights in a sequence based on the spatial pattern and the time lapse pattern, and to collect multiple pictures from multiple cameras surrounding the subject at each of the camera exposure windows.

In a third embodiment, a computer-implemented method for training a model to generate a relightable, three-dimensional representation of a subject includes illuminating the subject with multiple lights in a selected configuration including a spatial pattern and a time lapse pattern with multiple camera exposure windows including at least one light pulse within one or more lights illuminating the subject for at least one period of time, dynamically modifying the selected configuration for each of multiple user expressions, collecting multiple pictures from multiple cameras surrounding the subject at each of the camera exposure windows, generating, with a relightable appearance model, an expression-dependent texture map and a view-dependent texture map for the subject, based on the pictures, generating, based on the expression-dependent texture map and the view-dependent texture map, a synthetic view of the subject illuminated by the spatial pattern and the time lapse pattern, determining a loss value indicative of a difference between the synthetic view of the subject and at least one of the pictures including multiple views of the subject, updating the relightable appearance model based on the loss value, and storing the relightable appearance model in a memory circuit.

In other embodiments, a non-transitory, computer-readable medium stores instructions which, when executed by a processor, cause a computer to execute a method. The method includes selecting a lighting configuration for collecting a sequence of pictures of a subject, the lighting configuration including a spatial pattern with multiple lights surrounding the subject and a time lapse pattern with multiple camera exposure windows, modifying the spatial pattern and the time lapse pattern based on an average illumination intensity provided to the subject, activating the lights in a sequence based on the spatial pattern and the time lapse pattern, and collecting multiple pictures from multiple cameras surrounding the subject at each of the camera exposure windows.

In yet other embodiments, a system includes a first means to store instructions, and a second means to execute the instructions to cause the system to perform a method. The method includes selecting a lighting configuration for collecting a sequence of pictures of a subject, the lighting configuration including a spatial pattern with multiple lights surrounding the subject and a time lapse pattern with multiple camera exposure windows, modifying the spatial pattern and the time lapse pattern based on an average illumination intensity provided to the subject, activating the lights in a sequence based on the spatial pattern and the time lapse pattern, and collecting multiple pictures from multiple cameras surrounding the subject at each of the camera exposure windows.

These and other embodiments will become clear to one of ordinary skill in the art in light of the following.

### BRIEF DESCRIPTION OF THE FIGURES

FIG. 1 illustrates a network architecture configured for transferring personalized expressions to stylized avatars, according to some embodiments.

FIG. 2 is a block diagram illustrating a client device and a server for use in the architecture of FIG. 1, according to some embodiments.

FIG. 3 illustrates a studio for collecting multi-illumination, multi-view images of a subject for the universal prior model, according to some embodiments.

FIG. 4 illustrates a sequence of images collected in a relighting model session including interleaved fully illuminated frames during capture, according to some embodiments.

FIG. 5 illustrates a tracking pipeline for a modeling session of relightable avatars, according to some embodiments.

FIG. 6 illustrates a schematic representation of an interleaving illumination scheme, according to some embodiments.

FIG. 7 illustrates a partial view of an interleaving illumination scheme for a modeling session of relightable avatars, according to some embodiments.

FIG. 8 illustrates a partial view of an interleaving illumination scheme for a modeling session of relightable avatars reducing contrast for higher intensity light patterns, according to some embodiments.

FIG. 9 illustrates pictures of illumination schemes with and without interleaving from the point of view of an observer, according to some embodiments.

FIG. 10 is a flowchart including steps in a method 1000 for creating a personalized stylized avatar for immersive reality applications, according to some embodiments.

FIG. 11 is a block diagram illustrating components in a computer system for performing methods as disclosed herein, according to some embodiments.

In the figures, the same or similar reference numerals are associated with the same or similar features or attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Real-time rendering and animation of dynamic representations of humans is one of the cornerstones for games, movies, and VR telepresence applications. Embodiments as disclosed herein provide personalized expressive face avatars that can be rendered from novel viewpoints and relit to match the lighting in novel environments. However, during the modeling of the different lighting conditions to be trained by these models, the subject may suffer discomfort, or react adversely with an unnatural gesture or expression. To avoid model fatigue and training biases during the multiple and strenuous lighting setups, the present disclosure provides lighting configurations where the level of illumination remains constant, on average, and seemingly homogenous from the point of view of the subject in the middle.

In some embodiments, a relightable model as disclosed herein is built from light-stage captures of dynamic performances under a sparse set of space- and time-multiplexed illumination patterns. The time-multiplexed patterns include camera exposure windows distinctly marking the moments at which video capture is executed. Taking advantage of the short span of the camera exposure windows, and that the subject is unaware of when these windows occur, the present disclosure provides a time-multiplexed scheme wherein multiple lights are activated outside of the camera exposure windows to provide a time-averaged, homogeneous lighting condition that is more comfortable to the subject, while it has no interference on the relighting training of the model.

### Example System Architecture

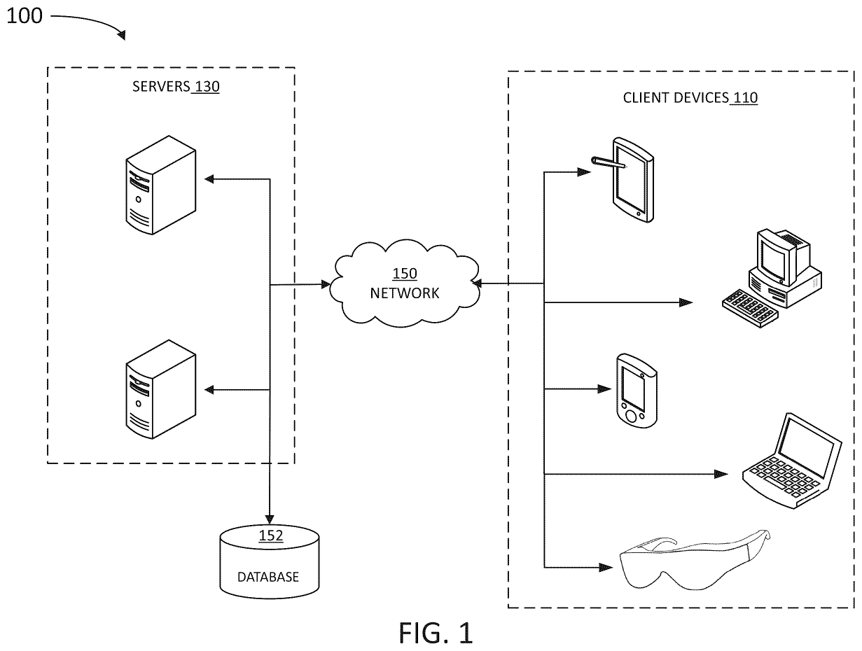

FIG. 1 illustrates an example architecture 100 suitable for accessing an avatar modeling engine, according to some embodiments. Architecture 100 includes servers 130 communicatively coupled with client devices 110 and at least one database 152 over a network 150. One of the many servers 130 is configured to host a memory including instructions which, when executed by a processor, cause the server 130 to perform at least some of the steps in methods as disclosed herein. In some embodiments, the processor is configured to control a graphical user interface (GUI) for the user of one of client devices 110 accessing the avatar modeling engine with a three-dimensional (3D) modeling application. Accordingly, the processor may include a dashboard tool, configured to display components and graphic results to the user via the GUI. For purposes of load balancing, multiple servers 130 can host memories including instructions to one or more processors, and multiple servers 130 can host a history log and a database 152 including multiple training archives used for the avatar modeling engine. Moreover, in some embodiments, multiple users of client devices 110 may access the same avatar modeling engine to model different avatars. In some embodiments, a single user with a single client device 110 may provide images and data to train one or more machine learning models running in parallel in one or more servers 130. Accordingly, client devices 110 and servers 130 may communicate with each other via network 150 and resources located therein, such as data in database 152.

Servers 130 may include any device having an appropriate processor, memory, and communications capability for hosting the avatar modeling engine including multiple tools associated with it. The avatar modeling engine may be accessible by various clients 110 over network 150. Client devices 110 can be, for example, desktop computers, mobile computers, tablet computers (e.g., including e-book readers), mobile devices (e.g., a smartphone or PDA), or any other device having appropriate processor, memory, and communications capabilities for accessing the avatar modeling engine on one or more of servers 130. In some embodiments, client devices 110 may include VR/AR headsets configured to run an immersive reality application supported by one or more of servers 130. Network 150 can include, for example, any one or more of a local area tool (LAN), a wide area tool (WAN), the Internet, and the like. Further, network 150 can include, but is not limited to, any one or more of the following tool topologies, including a bus network, a star network, a ring network, a mesh network, a star-bus network, tree or hierarchical network, and the like.

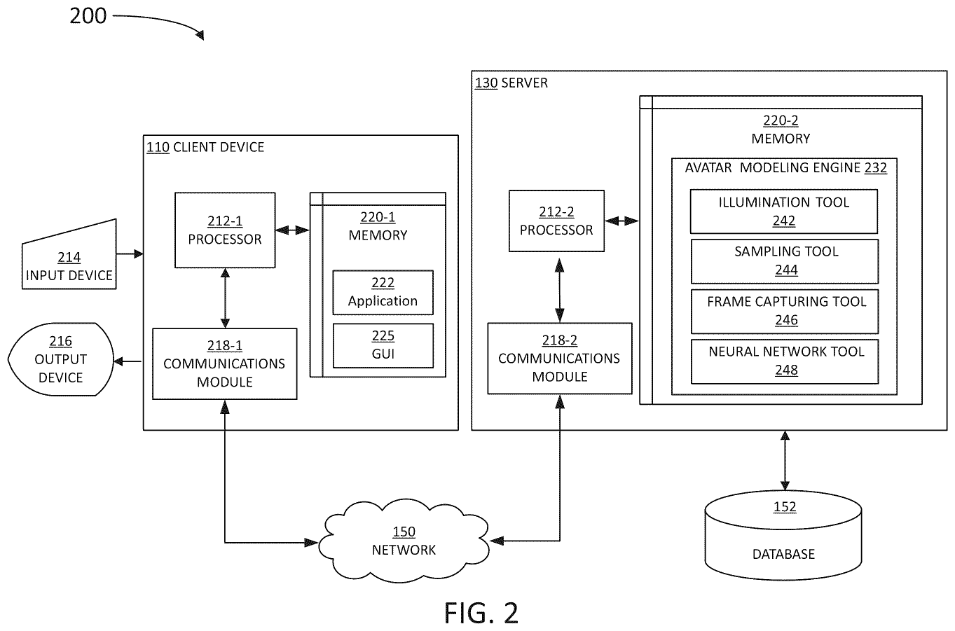

FIG. 2 is a block diagram 200 illustrating an example server 130, client device 110, and database 152 from architecture 100, according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices via network 150. Communications modules 218 can be, for example, modems or Ethernet cards, and may include radio hardware and software for wireless communications (e.g., via electromagnetic radiation, such as radiofrequency -RF-, near field communications -NFC-, Wi-Fi, and Bluetooth radio technology). A user may interact with client device 110 via an input device 214 and an output device 216. Input device 214 may include a mouse, a keyboard, a pointer, a touchscreen, a microphone, a joystick, a virtual joystick, and the like. In some embodiments, input device 214 may include cameras, microphones, and sensors, such as touch sensors, acoustic sensors, inertial motion units -IMUs- and other sensors configured to provide input data to a VR/AR headset. For example, in some embodiments, input device 214 may include an eye tracking device to detect the position of a user's pupil in a VR/AR headset. Output device 216 may be a screen display, a touchscreen, a speaker, and the like. Client device 110 may include a memory 220-1 and a processor 212-1. Memory 220-1 may include an application 222 and a GUI 225, configured to run in client device 110 and couple with input device 214 and output device 216. Application 222 may be downloaded by the user from server 130 and may be hosted by server 130. In some embodiments, client device 110 is a VR/AR headset and application 222 is an immersive reality application. In some embodiments, client device 110 is a mobile phone used to collect a video or picture and upload to server 130 using a video or image collection application 222, to store in training database 152. In yet other embodiments, client device 110 may be one of multiple (e.g., tens or hundreds, or even more) cameras and lamps in a modeling studio to generate an avatar for a subject.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an avatar modeling engine 232. Avatar modeling engine 232 may share or provide features and resources to GUI 225, including multiple tools associated with stylization, personalization, and animation, or design applications that use avatars retrieved with avatar modeling engine 232 (e.g., application 222). The user may access avatar modeling engine 232 through application 222, installed in a memory 220-1 of client device 110. Accordingly, application 222, including GUI 225, may be installed by server 130 and perform scripts and other routines provided by server 130 through any one of multiple tools. Execution of application 222 may be controlled by processor 212-1. In some embodiments, server 130 accesses and controls client devices (e.g., cameras and lamps in an avatar modeling studio) to generate a sequence of multi-view, multi-illumination pictures or frames of a subject.

Avatar modeling engine 232 may include an illumination tool 242, a sampling tool 244, a frame capturing tool 246, and a neural network tool 248. Illumination tool 242 provides light pulses to turn ‘on’ each of multiple lights in the avatar modeling studio. Sampling tool 244 elaborates a time sequence of camera exposure windows interspaced with the light pulses to be generated by illumination tool 242. Frame capturing tool 246 directs multiple cameras in the avatar modeling studio to collect a frame during the camera exposure windows selected by sampling tool 244. Neural network tool 248 is trained to generate a relightable avatar based on the multi-view, multi-illumination frames collected by frame capturing tool 246.

In some embodiments, neural network tool 248 may be part of one or more machine learning models stored in a database 252. Database 252 includes training archives and other data files that may be used by avatar modeling engine 232 in the preparation of illumination sequences for an avatar modeling studio. Moreover, in some embodiments, at least one or more training archives or machine learning models may be stored in either one of memories 220, and the user may have access to them through application 222.

Neural network tool 248 may include algorithms trained for the specific purposes of the engines and tools included therein. The algorithms may include machine learning or artificial intelligence algorithms making use of any linear or non-linear algorithm, such as a neural network algorithm, or multivariate regression algorithm. In some embodiments, the machine learning model may include a neural network (NN), a convolutional neural network (CNN), a generative adversarial neural network (GAN), a deep reinforcement learning (DRL) algorithm, a deep recurrent neural network (DRNN), a classic machine learning algorithm such as random forest, k-nearest neighbor (KNN) algorithm, k-means clustering algorithms, or any combination thereof. More generally, the machine learning model may include any machine learning model involving a training step and an optimization step. In some embodiments, training database 252 may include a training archive to modify coefficients according to a desired outcome of the machine learning model. Accordingly, in some embodiments, avatar modeling engine 232 is configured to access training database 252 to retrieve documents and archives as inputs for the machine learning model. In some embodiments, avatar modeling engine 232, the tools contained therein, and at least part of training database 252 may be hosted in a different server that is accessible by server 130 or client device 110.

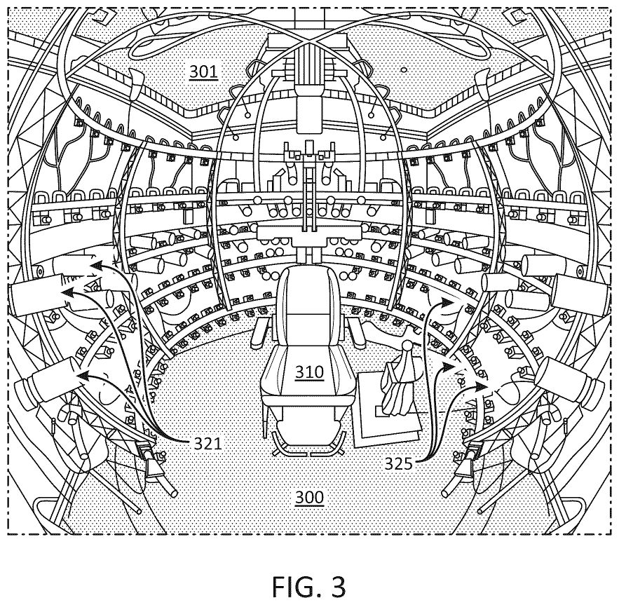

FIG. 3 illustrates a studio 300 (capture dome) for collecting multi-illumination, multi-view images of a subject for an avatar model, according to some embodiments. Modeling the avatar representation of a subject includes capture dome 301, a capture script, and a tracking pipeline. An avatar modeling engine as disclosed herein creates the tracking pipeline using an illumination tool, and a sampling tool as disclosed herein (cf. avatar modeling engine 232, illumination tool 242, sampling tool 244, and frame capturing tool 246). To capture synchronized multi-view videos of a facial performance, capture dome 301 includes multiple video cameras 325 (monochrome and polychrome cameras) placed on a spherical structure with a selected radius (e.g., 1.2 meters or more). Cameras 325 are pointed towards the center of the spherical structure where the subject's head is situated (the subject is seated on seat 310). In some embodiments, the video capture is collected at a resolution of 4096×2668 pixels with a shutter speed of 2.222 ms at 90 frames per second. Multiple (e.g., 350, or more) point light sources 321 are evenly distributed across the structure to uniformly illuminate the participant. To compute the intrinsic and extrinsic parameters of each camera 325, a robot arm includes a 3D calibration target to perform automatic geometric camera calibration.

A capture script systematically guides the subject through a wide range of facial expressions for each amount of time. The subjects are asked to go through the following exercises: 1) mimic 65 distinct facial expressions, 2) perform a free-form facial range-of-motion segment, 3) look in 25 different directions to represent various gaze angles, and 4) read 50 phonetically balanced sentences. In some embodiments, 255 subjects are captured, and an average of 12,000 subsampled frames were recorded per subject. Accordingly, 3.1 million frames are processed. For building the datasets, the capture script may be designed to span the range of facial expressions, as much as possible. Accordingly, avatar models as disclosed herein can reproduce some rare or extreme expressions.

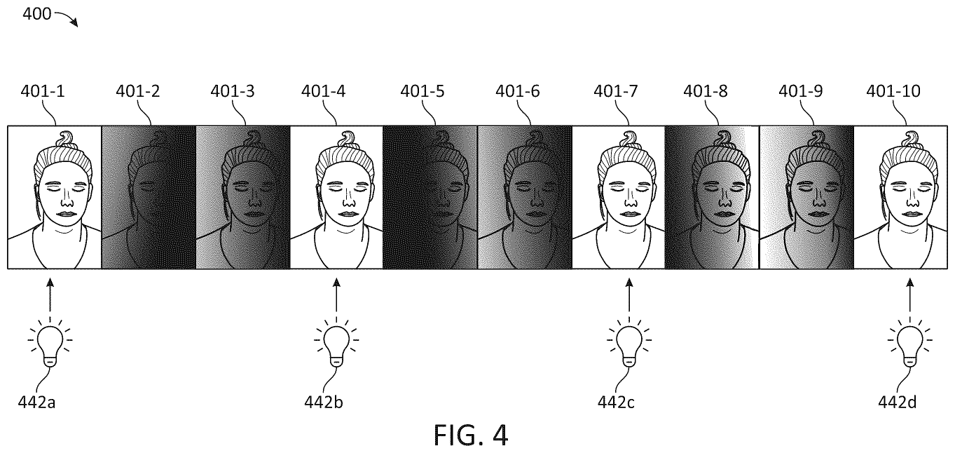

FIG. 4 illustrates a sequence 400 (e.g., tracking pipeline) of images or frames 401-1, 401-2, 401-3, 401-4, 401-5, 401-6, 401-7, 401-8, 401-9, and 401-10 (hereinafter, collectively referred to as “frames 401”) collected in a relighting model session including interleaved fully illuminated frames 401-1, 401-4, 401-7, and 401-10 during capture (hereinafter, collectively referred to as “fully illuminated frames 401”), according to some embodiments. While some of frames 401 may be collected while all, some, or only one of the multiple lights in the avatar modeling studio are turned on, the cameras collecting each frame may include one or more, or all of the multi-directional cameras in the studio (cf. cameras 325).

As illustrated, fully illuminated frames 401 are interspersed in sequence 400 for feature tracking by the processing algorithms (cf. neural network 248). Accordingly, in some embodiments, fully illuminated frames 401 are captured by one or more of the cameras around the subject (cf. cameras 325), such that these frames may be used by the training algorithm for tracking facial features that may be obscured in other frames, where illumination is sparse. Illumination settings 442a, 442b, 442c, and 442d (hereinafter, collectively referred to as “illumination frames 442”) for providing fully illuminated frames 401 may include all, or almost all of the lights in the avatar modeling studio turned “on.” Notice that the expression of the subject in fully illuminated frames 401 may be different. In fact, in some embodiments, it is desirable that fully illuminated frames 401 include at least one of each of the different expressions in the capture script.

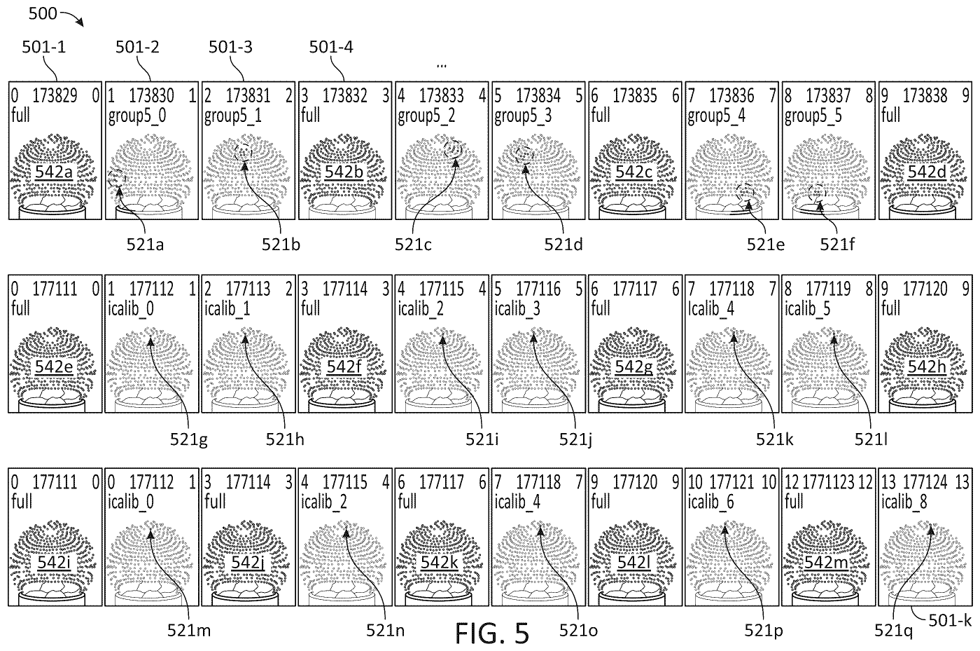

FIG. 5 illustrates a tracking pipeline 500 with spatial and temporal variations of an interleaving illumination scheme for a modeling session of relightable avatars, according to some embodiments. Each picture 501-1, 501-2, 501-3, 501-4, up to 501-k (where k is any integer), hereinafter collectively referred to as “pictures 501,” corresponds to a frame capturing event in a tracking pipeline, according to some embodiments. Each of images 501 depict a representation of the entire lighting setting surrounding the subject (who is seated at the center of the elongated dark area at the bottom) in an avatar modeling studio. The images in panel 500 show a reflection onto a spherical surface simply to give a broad perspective of all the lights being used, and their relative orientation with respect to the subject, at the center bottom of each image 501. Accordingly, tracking pipeline 500 includes fully illuminated sets 542a, 542b, 542c, 542d, 542e, 542f, 542g, 542h, 542i, 542j, 542k, 542l, and 542m, (hereinafter, collectively referred to as “fully illuminated sets 542”). Tracking pipeline 500 may also include partially illuminated frames wherein the one or more lights that are turned ‘on’ in the set are indicated as lights 521a, 521b, 521c, 521d, 521e, 521f, 521g, 521h, 521i, 521j, 521k, 521l, 521m, 521n, 521o, 521p, and 521q (hereinafter, collectively referred to as lights 521). In some embodiments, for each of the frames collected in images 501, one or more, or all of the cameras in the avatar modeling studio may be turned on.

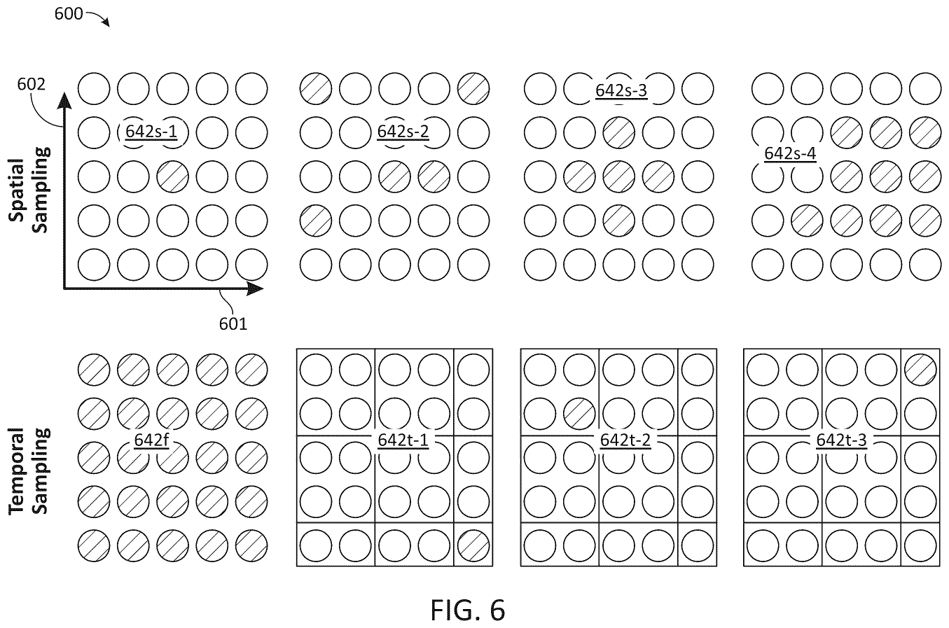

FIG. 6 illustrates a schematic representation of an interleaving illumination scheme 600, according to some embodiments. The figure illustrates exemplary lighting patterns in the spatial domain 642s-1, 642s-2, 642s-3, and 642s-4 (hereinafter, collectively referred to as “lighting patterns 642s”), fully illuminated 642f and in the time domain 642t-1, 642t-2, and 642t-3 (hereinafter, collectively referred to as “lighting patterns 642t”). The cartesian coordinates 601 and 602 are angular variables (sagittal and azimuthal) that span the entirety of the “dome” in the modeling studio (cf. capture dome 301).

A one-light-at-a-time (OLAT) pattern 642s-1 may randomly select one light per capture. Other configurations may include a random distribution of a fixed number of lights being turned on simultaneously (e.g., five lights 642s-2 and 642s-3, ten lights 642s-4, and the like). In the time domain, OLAT configurations 642t-1, 642t-2, and 642t-3 may follow after a fully illuminated capture 642f.

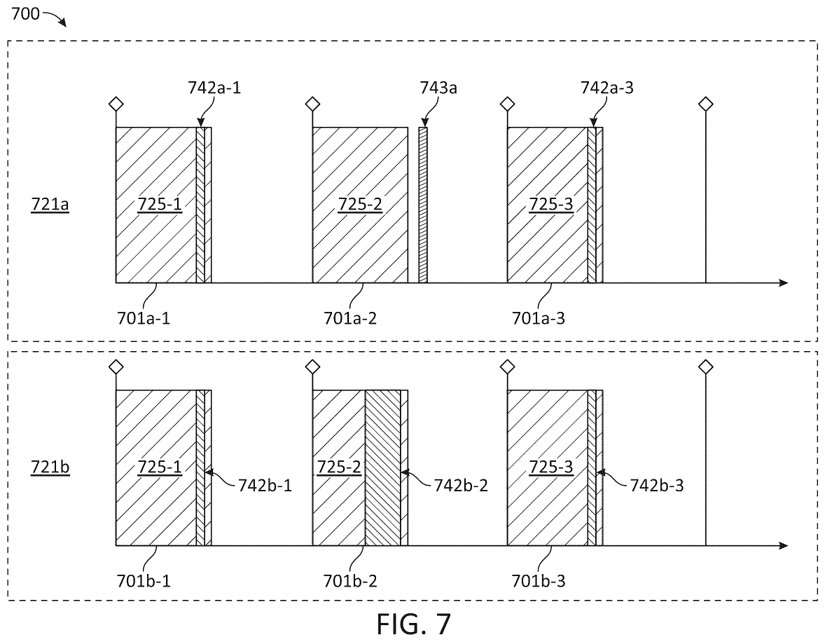

FIG. 7 illustrates a partial view of an interleaving illumination scheme 700 for a modeling session of relightable avatars, according to some embodiments. Each of the two rows of time-multiplexing patterns corresponds to a different light 721a and 721b (hereinafter, collectively referred to as “lights 721”) in the setup. Accordingly, a full view would include as many rows as there are lights in the avatar modeling studio (e.g., 100, 200, . . . and up to 400, or more). The abscissae in the charts indicate time, and the ordinates a signal amplitude. Illumination scheme 700 illustrates camera exposure windows 725-1, 725-2, and 725-3 (hereinafter, collectively referred to as “camera exposure windows 725”) and light pulse events 742a-1, 743a, 742a-3, 742b-1, 742b-2, and 742b-3 (hereinafter, collectively referred to as “lighting events 742a, 742b, and 743a”). Camera exposure windows 725 are intervals during which a selected one or more, or all of the cameras in the avatar modeling studio are turned on for collecting a frame 701a-1, 701a-2 and 701a-3 (for light 721a, hereinafter, collectively referred to as “frames 701a”) and a frame 701b-1, 701b-2, and 701b-3 (for light 721b, hereinafter, collectively referred to as “frames 701b”). Lighting events 742a and 742b are lighting events that occur within a camera exposure window 725. Lighting event 743a occurs outside of any camera exposure window 725 and the desired training effect (light 721a ‘off’ and light 721b ‘on’) is obtained without artifacts from user discomfort or subconscious reaction from the subject. More specifically, a frame collected in camera exposure window 725 will show the subject illuminated only by light 721b, but the subject will perceive the same illumination pattern as for frames 725-1 and 725-2.

In the figure, after three camera exposure windows 725, light 725b has provided substantially longer illumination power onto the subject. More specifically, while on frame 725-2, light 721b has a substantive illuminating light pulse 742b-2, and light 721a is ‘off.’ This imbalance, while relevant for frame capture, is unnoticed by the subject due to the off-exposure light pulse 743a, thus avoiding a potential subconscious reaction of the subject to a change in illumination pattern perception that may alter the facial features of the subject in an undesirable or unnatural way. Accordingly, the time lapses involved between light pulse 743a and camera exposure window 725-2 is so short that the subject cannot distinguish that light 721a and light 721b may be turned on at slightly different times, and therefore not notice a flicker or a change in overall lighting intensity.

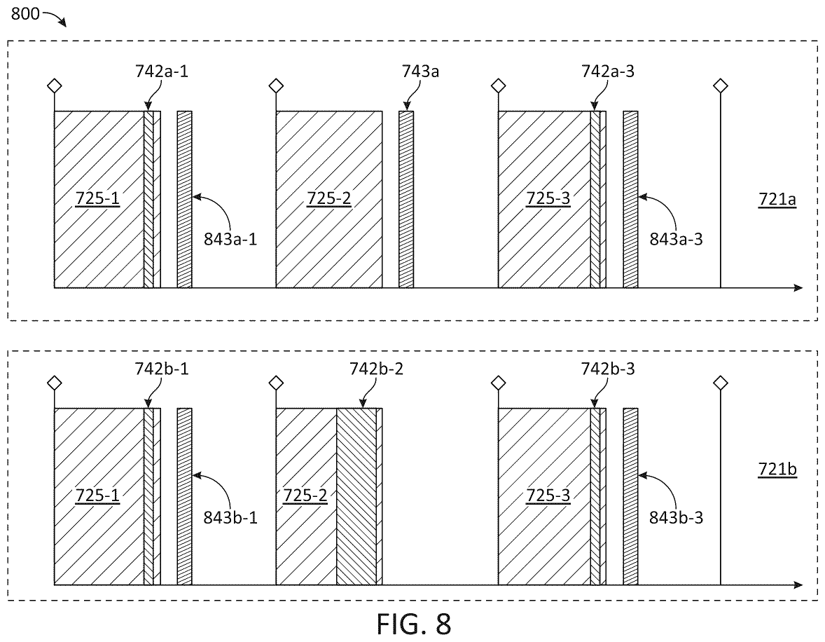

FIG. 8 illustrates a partial view of an interleaving illumination scheme 800 for a modeling session of relightable avatars reducing contrast for higher intensity light patterns, according to some embodiments. In the figure, lighting events 742a, 743a, and 742b remain the same as in illumination scheme 700. However, the interleaved time multiplexing pattern for light 721a includes after-exposure light pulses 843a-1 for camera exposure window 725-1, and 843a-3 for camera exposure window 725-3. Time multiplexing for light 721b includes after exposure pulses 843b-1 for camera exposure window 725-1, and 843b-3 for camera exposure window 725-3. Accordingly, on average, after the frames from camera exposure windows 725 have gone by, light 721a has emitted about the same or similar amount of light as light 721b, even though the captured amount is substantially higher for light 721b. Accordingly, the subject feels like no lighting condition has changed appreciably during the whole exposure session, which is the desired goal.

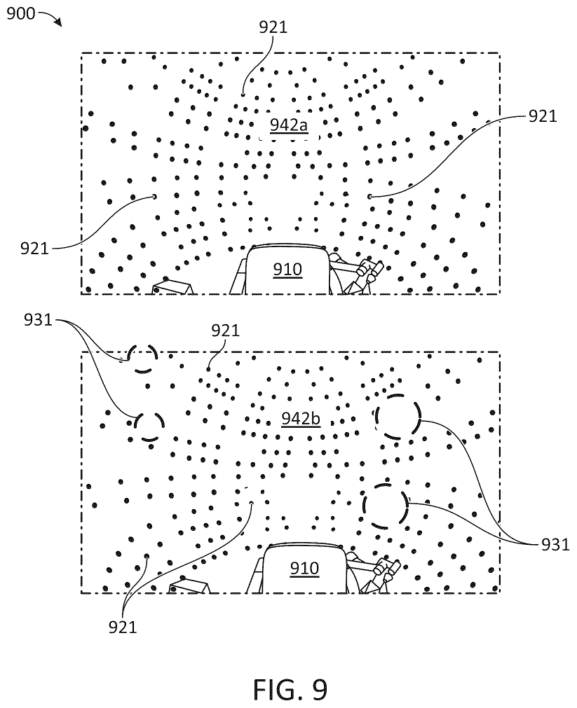

FIG. 9 illustrates a picture of illumination schemes 900 with 942a and without 942b interleaving from the point of view of an observer (hereinafter, collectively referred to as “illumination schemes 942”), according to some embodiments. The subject's seat 910 is illustrated as a reference point. Without interleaving light pulses between and outside of camera exposure windows (scheme 942b), the illumination fields 921 look spotty, with gaps 931 that flicker from one moment to another. Using an interleaving scheme for light pulses (scheme 942a), the illumination session seems more homogeneous (space) and constant (time), as is desirable, to have an undisturbed subject making natural gestures.

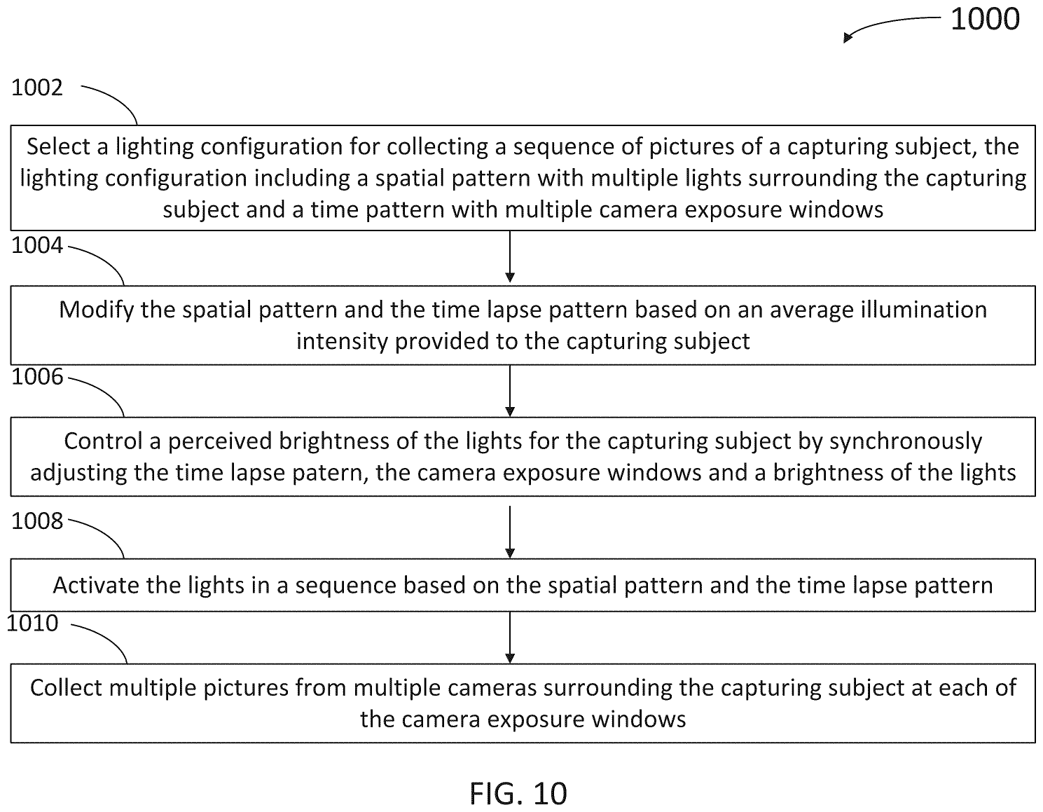

FIG. 10 is a flowchart including steps in a method 1000 for creating a personalized stylized avatar for immersive reality applications, according to some embodiments. Steps in method 1000 may be performed by a processor circuit in a computer, executing instructions stored in a memory circuit of the computer. In some embodiments, methods consistent with the present disclosure may include at least one or more of the steps in method 1000, performed in a different order, simultaneously, quasi-simultaneously, or overlapping in time.

Step 1002 includes selecting a lighting configuration for collecting a sequence of pictures of a subject, the lighting configuration including a spatial pattern with multiple lights surrounding the subject and a time lapse pattern with multiple camera exposure windows. In some embodiments, step 1002 includes selecting the spatial pattern and the time lapse pattern based on an environment map including multiple lighting configurations in an environment for the subject in an immersive reality application. In some embodiments, step 1002 includes selecting a random group of lights forming the spatial pattern, the random group of lights activated by a light pulse within a random camera exposure window, such that each camera exposure window has no more than one light pulse within. In some embodiments, step 1002 includes selecting a light pulse on a random camera exposure window, such that each camera exposure window has no more than a selected number of light pulses within. In some embodiments, step 1002 includes selecting a first group of lights forming the spatial pattern, and a second group of lights outside of the spatial pattern and associating each of the first group of lights with a light pulse within a camera exposure window and each of the second group of lights with a light pulse outside any camera exposure window.

Step 1004 includes modifying the spatial pattern and the time lapse pattern based on an average illumination intensity provided to the subject. In some embodiments, step 1004 includes adding a light pulse for a first light in the time lapse pattern that is outside of a camera exposure window that has no light pulse within. In some embodiments, step 1004 includes adding a light pulse for a first light in the time lapse pattern that is outside of a camera exposure window that includes a light pulse for a second light in the time lapse pattern. In some embodiments, step 1004 includes adding a light pulse outside of a camera exposure window for a first light located in a first position relative to the subject, wherein the camera exposure window includes a light pulse for a second light located in a second position symmetric to the first position relative to the subject. In some embodiments, step 1004 includes adding multiple light pulses for multiple lights outside of any camera exposure window such that an average illumination intensity on the subject is constant and homogenous. In some embodiments, step 1004 includes adding multiple light pulses for multiple lights outside of any camera exposure window to reduce an illumination contrast on the subject.

Step 1006 includes controlling a perceived brightness of the lights for the capturing subject by synchronously adjusting the time lapse pattern, the camera exposure windows and a brightness of the lights. In some embodiments, step 1006 includes decorrelating the time lapse pattern with the camera exposure windows.

Step 1008 includes activating the lights in a sequence based on the spatial pattern and the time lapse pattern.

Step 1010 includes collecting multiple pictures from multiple cameras surrounding the subject at each of the camera exposure windows.

### Hardware Overview

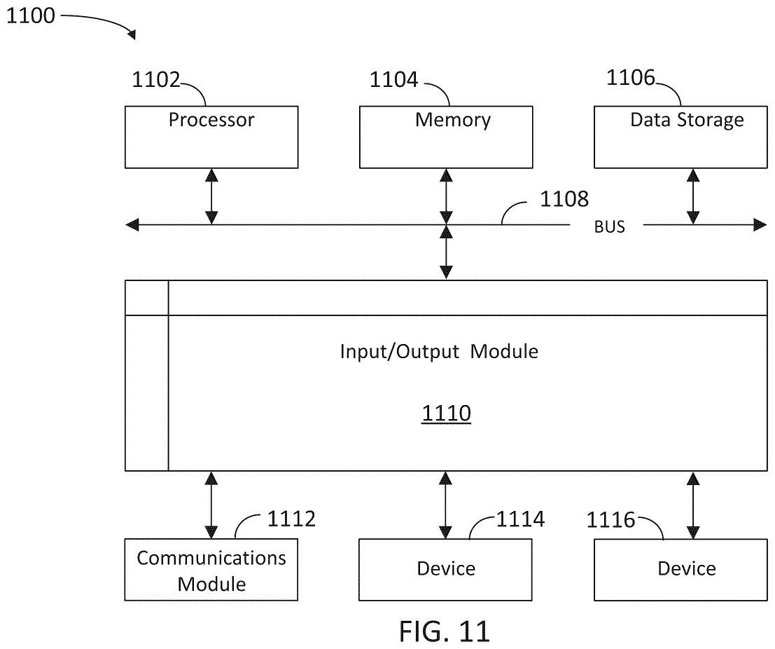

FIG. 11 is a block diagram illustrating an exemplary computer system 1100 with which headsets and other client devices 110, and method 1000 can be implemented. In certain aspects, computer system 1100 may be implemented using hardware or a combination of software and hardware, either in a dedicated server, or integrated into another entity, or distributed across multiple entities. Computer system 1100 may include a desktop computer, a laptop computer, a tablet, a phablet, a smartphone, a feature phone, a server computer, or otherwise. A server computer may be located remotely in a data center or be stored locally.

Computer system 1100 includes a bus 1108 or other communication mechanism for communicating information, and a processor 1102 (e.g., processors 212) coupled with bus 1108 for processing information. By way of example, the computer system 1100 may be implemented with one or more processors 1102. Processor 1102 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1100 can include, in addition to hardware, code that creates an execution environment for the computer program in question, e.g., code that constitutes processor firmware, a protocol stack, a database management system, an operating system, or a combination of one or more of them stored in an included memory 1104 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 1108 for storing information and instructions to be executed by processor 1102. The processor 1102 and the memory 1104 can be supplemented by, or incorporated in, special purpose logic circuitry.

The instructions may be stored in the memory 1104 and implemented in one or more computer program products, e.g., one or more modules of computer program instructions encoded on a computer-readable medium for execution by, or to control the operation of, the computer system 1100, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1104 may also be used for storing temporary variable or other intermediate information during execution of instructions to be executed by processor 1102.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1100 further includes a data storage device 1106 such as a magnetic disk or optical disk, coupled with bus 1108 for storing information and instructions. Computer system 1100 may be coupled via input/output module 1110 to various devices. Input/output module 1110 can be any input/output module. Exemplary input/output modules 1110 include data ports such as USB ports. The input/output module 1110 is configured to connect to a communications module 1112. Exemplary communications modules 1112 include networking interface cards, such as Ethernet cards and modems. In certain aspects, input/output module 1110 is configured to connect to a plurality of devices, such as an input device 1114 and/or an output device 1116. Exemplary input devices 1114 include a keyboard and a pointing device, e.g., a mouse or a trackball, by which a consumer can provide input to the computer system 1100. Other kinds of input devices 1114 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 1116 include display devices, such as an LCD (liquid crystal display) monitor, for displaying information to the consumer.

According to one aspect of the present disclosure, headsets and client devices 110 can be implemented, at least partially, using a computer system 1100 in response to processor 1102 executing one or more sequences of one or more instructions contained in memory 1104. Such instructions may be read into memory 1104 from another machine-readable medium, such as data storage device 1106. Execution of the sequences of instructions contained in main memory 1104 causes processor 1102 to perform the process steps described herein. One or more processors in a multi-processing arrangement may also be employed to execute the sequences of instructions contained in memory 1104. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1100 can include clients and servers. A client and server are generally remote from each other and typically interact through a communication network. The relationship of client and server arises by virtue of computer programs running on the respective computers and having a client-server relationship to each other. Computer system 1100 can be, for example, and without limitation, a desktop computer, laptop computer, or tablet computer. Computer system 1100 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1102 for execution. Such a medium may take many forms, including, but not limited to, non-volatile media, volatile media, and transmission media. Non-volatile media include, for example, optical or magnetic disks, such as data storage device 1106. Volatile media include dynamic memory, such as memory 1104. Transmission media include coaxial cables, copper wire, and fiber optics, including the wires forming bus 1108. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

The subject technology is illustrated, for example, according to various aspects described below. Various examples of aspects of the subject technology are described as numbered claims (claim 1, 2, etc.) for convenience. These are provided as examples, and do not limit the subject technology.

In one aspect, a method may be an operation, an instruction, or a function and vice versa. In one aspect, a claim may be amended to include some or all of the words (e.g., instructions, operations, functions, or components) recited in either one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the user technology, the disclosure, the present disclosure, other variations thereof and alike are for convenience only and do not imply that a disclosure relating to such phrase(s) is essential to the user technology or that such disclosure applies to all configurations of the user technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the user technology, and are not referred to in connection with the interpretation of the description of the user technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the user technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the user matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can, in some cases, be excised from the combination, and the described combination may be directed to a subcombination or variation of a subcombination.

The user matter of this specification has been described in terms of particular aspects, but other aspects can be implemented and are within the scope of the above claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, drawings and description thereof are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples, and the various features are grouped together in various implementations for the purpose of streamlining the disclosure. The method of disclosure is not to be interpreted as reflecting an intention that the described user matter requires more features than are expressly recited in each claim. Rather, as the claims reflect, inventive user matter lies in less than all features of a single disclosed configuration or operation. The claims are hereby incorporated into the detailed description, with each claim standing on its own as a separately described user matter.

The claims are not intended to be limited to the aspects described herein but are to be accorded the full scope consistent with the language claims and to encompass all legal equivalents. Notwithstanding, none of the claims are intended to embrace user matter that fails to satisfy the requirements of the applicable patent law, nor should they be interpreted in such a way.

What is claimed is:

1. A computer-implemented method, comprising:
selecting a lighting configuration for collecting a sequence of pictures of a capturing subject, the lighting configuration including a spatial pattern with multiple lights surrounding the capturing subject and a time lapse pattern with multiple camera exposure windows;
modifying the spatial pattern and the time lapse pattern based on an average illumination intensity provided to the capturing subject;
controlling a perceived brightness of the lights for the capturing subject by synchronously adjusting the time lapse pattern, the camera exposure windows and a brightness of the lights;
activating the lights in a sequence based on the spatial pattern and the time lapse pattern; and
collecting multiple pictures from multiple cameras surrounding the capturing subject at each of the camera exposure windows.

2. The computer-implemented method of claim 1, wherein controlling the perceived brightness of the lights comprises decorrelating the time lapse pattern with the camera exposure windows.

3. The computer-implemented method of claim 1, wherein selecting a lighting configuration for collecting a sequence of pictures of a subject comprises selecting a random group of lights forming the spatial pattern, the random group of lights activated by a light pulse within a random camera exposure window, such that each camera exposure window has no more than one light pulse within.

4. The computer-implemented method of claim 1, wherein selecting a time lapse pattern comprises selecting a light pulse on a random camera exposure window, such that each camera exposure window has no more than a selected number of light pulses within.

5. The computer-implemented method of claim 1, wherein selecting a lighting configuration for collecting a sequence of pictures of a subject comprises selecting a first group of lights forming the spatial pattern, and a second group of lights outside of the spatial pattern, and associating each of the first group of lights with a light pulse within a camera exposure window and each of the second group of lights with a light pulse outside any camera exposure window.

6. The computer-implemented method of claim 1, wherein modifying the time lapse pattern comprises including a light pulse for a first light in the time lapse pattern that is outside of a camera exposure window that has no light pulse within.

7. The computer-implemented method of claim 1, wherein modifying the time lapse pattern comprises including a light pulse for a first light in the time lapse pattern that is outside of a camera exposure window that includes a light pulse for a second light in the time lapse pattern.

8. The computer-implemented method of claim 1, wherein modifying the spatial pattern comprises adding a light pulse outside of a camera exposure window for a first light located in a first position relative to the capturing subject, wherein the camera exposure window includes a light pulse for a second light located in a second position symmetric to the first position relative to the capturing subject.

9. The computer-implemented method of claim 1, wherein modifying the spatial pattern and the time lapse pattern comprises adding multiple light pulses for multiple lights outside of any camera exposure window such that an average illumination intensity on the capturing subject is constant and homogenous.

10. The computer-implemented method of claim 1, wherein modifying the spatial pattern and the time lapse pattern comprises adding multiple light pulses for multiple lights outside of any camera exposure window to reduce an illumination contrast on the capturing subject.

11. A system, comprising:
a memory storing multiple instructions; and
one or more processors configured to execute the instructions to cause the system to:
select a lighting configuration for collecting a sequence of pictures of a subject, the lighting configuration including a spatial pattern with multiple lights surrounding the subject and a time lapse pattern with multiple camera exposure windows;
modify the spatial pattern and the time lapse pattern based on an average illumination intensity provided to the subject;
control a perceived brightness of the lights for the subject by synchronously adjusting the time lapse pattern, the camera exposure windows and a brightness of the lights;
activate the lights in a sequence based on the spatial pattern and the time lapse pattern; and
collect multiple pictures from multiple cameras surrounding the subject at each of the camera exposure windows.

12. The system of claim 11, wherein to modify the time lapse pattern the one or more processors execute instructions to include a light pulse for a first light in the time lapse pattern that is outside of a camera exposure window that has no light pulse within.

13. The system of claim 11, wherein to modify the time lapse pattern the one or more processors execute instructions to include a light pulse for a first light in the time lapse pattern that is outside of a camera exposure window that includes a light pulse for a second light in the time lapse pattern.

14. The system of claim 11, wherein to modify the spatial pattern the one or more processors execute instructions to add a light pulse outside of a camera exposure window for a first light located in a first position relative to the subject, wherein the camera exposure window includes a light pulse for a second light located in a second position symmetric to the first position relative to the subject.

15. A computer-implemented method for training a model to generate a relightable, three-dimensional representation of a subject, comprising:
illuminating the subject with multiple lights in a selected configuration including a spatial pattern and a time lapse pattern with multiple camera exposure windows including at least one light pulse within and one or more lights illuminating the subject for at least one period of time;
dynamically modifying the selected configuration for each of multiple user expressions;
collecting multiple pictures from multiple cameras surrounding the subject at each of the camera exposure windows;
generating, with a relightable appearance model, an expression-dependent texture map and a view-dependent texture map for the subject, based on the pictures;
generating, based on the expression-dependent texture map and the view-dependent texture map, a synthetic view of the subject illuminated by the spatial pattern and the time lapse pattern;
determining a loss value indicative of a difference between the synthetic view of the subject and at least one of the pictures including multiple views of the subject;
updating the relightable appearance model based on the loss value; and
storing the relightable appearance model in a memory circuit.

16. The computer-implemented method of claim 15, further comprising building a real-time model to generate a representation of a subject using multiple synthetic views of multiple subjects generated by the model to generate a relightable, three-dimensional representation of a subject.

17. The computer-implemented method of claim 15, further comprising selecting the spatial pattern and the time lapse pattern to provide a constant illumination intensity to the subject.

18. The computer-implemented method of claim 15, further comprising selecting the spatial pattern to provide a homogeneous illumination intensity to the subject.

19. The computer-implemented method of claim 15, further comprising selecting the spatial pattern and the time lapse pattern based on complementary lighting configurations, a fully lit lighting configuration, and a single light lighting configuration.

20. The computer-implemented method of claim 15, further comprising adding multiple light pulses for multiple lights outside of any camera exposure window to reduce an illumination contrast on the subject.
